(19) United States
(12) Patent Application Publication
(10) Pub. No.: US 2025/0270831 A1
(43) Pub. Date: Aug. 28, 2025

(54) ROBOTIC BLOCK LAYING MACHINE IMPROVEMENTS

(71) Applicant: FASTBRICK IP PTY LTD, High Wycombe (AU)

(72) Inventors: Mark Joseph Pivac, High Wycombe (AU); Maarten Frank Kornaat, High Wycombe (AU)

(21) Appl. No.: 18/857,337

(22) PCT Filed: Apr. 20, 2023
(86) PCT No.: PCT/AU2023/050325

§ 371 Date: Oct. 16, 2024

(30) Foreign Application Priority Data
Apr. 20, 2022 (AU) 2022901044

(51) Int. Cl. E04G 21/22; B25J 5/04; B25J 15/00; B25J 15/02; E04B 2/02

(52) U.S. Cl. CPC E04G 21/22; B25J 5/04; B25J 15/0047; B25J 15/0253; E04B 2002/0258

(57) ABSTRACT

The present disclosure provides a vehicle which incorporates a robotic block laying machine for use in constructing a block structure, the vehicle including: (a) a vehicle chassis: (b) a base frame mounted to the chassis; and, (c) a robotic block laying machine mounted from the base frame, the machine including: (i) one or more loading bays for receiving pallets of blocks stacked with one or more courses of blocks wherein each course comprises a plurality of rows of blocks; (ii) at least one robotic arm configured to pick any individual block directly from a course of the pallet; and, (iii) a block conveying system that receives blocks from the at least one robotic arm and transports them to a laying head of the machine that lays the blocks in order to create the block structure.

### PRIORITY DOCUMENTS

The present application claims priority from Australian Provisional Application No. 2022901044 titled “ROBOTIC CONSTRUCTION MACHINE IMPROVEMENTS” as filed on 20 Apr. 2022, the content of which is hereby incorporated by reference in its entirety.

### BACKGROUND OF THE INVENTION

The present invention relates to improvements for a robotic block laying machine for use in constructing walls of a building.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Autonomous and semi-autonomous industrial robotic equipment is increasingly being used in outside work environments such as on construction sites, building sites, mining sites, and industrial sites. For example, WO 2007/076581 describes an automated brick laying system for constructing a building from a plurality of bricks comprising a robot provided with a brick laying and adhesive applying head, a measuring system, and a controller that provides control data to the robot to lay the bricks at predetermined locations. The measuring system measures in real time the position of the head and produces position data for the controller. The controller produces control data on the basis of a comparison between the position data and a predetermined or pre-programmed position of the head to lay a brick at a predetermined position for the building under construction. The controller can control the robot to construct the building in a course by course manner where the bricks are laid sequentially at their respective predetermined positions and where a complete course of bricks for the entire building is laid prior to laying of the bricks for the next course.

In Applicant's earlier publication WO2018/009981, there is provided a self-contained truck-mounted brick laying machine. A truck supports the brick laying machine which is mounted on a frame on the truck chassis. The frame supports packs or pallets of bricks loaded into the machine into loading bays. Dehacker robots then dehack (i.e. remove) entire rows of bricks from the pallets and place them onto a platform. A transfer robot can then pick up an individual brick from the platform and move it to, or between either a saw or a router or a carousel. The carousel is located coaxially with a tower, at the base of the tower. The carousel transfers the brick via the tower to an articulated (folding about horizontal axis) telescoping boom comprising first boom element in the form of telescopic boom and second boom element in the form of telescopic stick. The bricks are moved along the folding telescoping boom by linearly moving shuttles, to reach a brick laying and adhesive applying head.

In the above-described arrangement, pallets of full-sized bricks are loaded into the machine and any bricks that need cutting to size are put into an on-board saw which performs the cutting operation. As a result of this cutting process, there are often off-cuts which are not required at that point in the build sequence which end up being discarded by the robot into a waste chute. Consequently, there is inevitably some construction waste that accumulates for each build which would be desirable to minimise.

The use of a saw also adds an additional handling process which sometimes slows the overall laying rate of the machine. It is desirable to increase the laying rate to improve machine economics whilst also reducing the brick handling operations on the machine to improve overall machine reliability.

The dehacker robots which remove entire rows of bricks from pallets loaded into the machine also represent an additional brick handling operation for the robot. It would be desirable to remove as many brick handling operations for the machine as possible in order to improve reliability.

### SUMMARY OF THE PRESENT INVENTION

In one broad form, an aspect of the present invention seeks to provide a vehicle which incorporates a robotic block laying machine for use in constructing a block structure, the vehicle including:
a) a vehicle chassis:
b) a base frame mounted to the chassis; and,
c) a robotic block laying machine mounted from the base frame, the machine including:
   i) one or more loading bays for receiving pallets of blocks stacked with one or more courses of blocks wherein each course comprises a plurality of rows of blocks;
   ii) at least one robotic arm configured to pick any individual block directly from a course of the pallet; and,
   iii) a block conveying system that receives blocks from the at least one robotic arm and transports them to a laying head of the machine that lays the blocks in order to create the block structure.

In one embodiment, one or more of the pallets are stacked with pre-sequenced blocks in accordance with a block sequence generated by a build datafile associated with the block structure.

In one embodiment, the courses of blocks arranged in a pre-sequenced order include blocks of varying length.

In one embodiment, the blocks of varying length are one of pre-cut and moulded.

In one embodiment, for blocks having internal cores, the at least one robotic arm is configured with a gripper having a pair of fingers that are insertable into one or more of the internal cores to apply a force thereby enabling the arm to pick up a block directly from the pallet.

In one embodiment, the pair of fingers are inserted into a single core and controllable to each apply an outwardly directed force to faces of the core.

In one embodiment, the pair of fingers are inserted into separate cores and controllable to each apply an inwardly directed force to faces of the separate cores.

In one embodiment, the separate cores are outermost cores of a block.

In one embodiment, the fingers of the gripper have gripper pads fixed to sides of each finger.

In one embodiment, for blocks without internal cores, the at least one robotic arm is configured with a vacuum gripper to pick up a block directly from the pallet.

In one embodiment, the at least one robot arm includes a vision sensor for scanning one or more blocks on a pallet, wherein an image captured by the vision sensor is processed to identify a target block to be picked and calculate an offset between an expected position and an actual position of the target block.

In one embodiment, the vision sensor is mounted to the robot arm proximate the gripper.

In one embodiment, the robot arm is moved so that the gripper is positioned above the expected location of the target block on the pallet, the height of the gripper above the pallet sufficient to obtain an image of at least the entire target block.

In one embodiment, an image is captured and processed to determine an X, Y and C (yaw) offset from an expected position.

In one embodiment, the vision sensor further determines a Z height indicative of the vertical distance between the sensor and the block.

In one embodiment, the determined Z height and X, Y and C offsets are used to control the robot arm to move the gripper just above the block.

In one embodiment, the robot arm is controlled to pick the block by inserting the gripper fingers into the one or more cores and then closing or opening the gripper to pick the block.

In one embodiment, the vision sensor is a time of flight (ToF) sensor.

In one embodiment, the block conveying system includes:
a) a tower mounted to the base for rotation about a vertical axis, the tower having a tower shuttle that runs along a tower track for transporting a block up the tower;
b) a foldable and telescopically extendable boom pivotally mounted to the tower about a horizontal axis, wherein rotation of the tower sweeps the boom radially about the vertical axis and wherein the laying head is mounted to a distal end of the boom, the boom having a shuttle system for transporting blocks from the tower to the laying head; and,
c) a carousel located around a base of the tower and rotatable about the vertical axis independently of the tower, the carousel having one or more clamping bays for receiving blocks from the at least one robotic arm,
wherein, in use, the at least one robotic arm is configured to transfer a block picked from a pallet to a clamping bay of the carousel which rotates to a position proximate the tower track for transfer of the block to the tower shuttle which conveys the block up the tower where it is then transferred to the boom shuttle system.

It will be appreciated that the broad forms of the invention and their respective features can be used in conjunction and/or independently, and reference to separate broad forms is not intended to be limiting.

### BRIEF DESCRIPTION OF THE DRAWINGS

Various examples and embodiments of the present invention will now be described with reference to the accompanying drawings, in which:

FIG. 1A is a schematic side view of an example of a vehicle which incorporates a robotic block laying machine;

FIG. 1B is a schematic rear view of the vehicle of FIG. 1A;

FIG. 1C is a schematic top view of the vehicle of FIG. 1A;

FIG. 2A is a perspective view of an example of a robotic arm configured to pick an individual block directly from a pallet of blocks;

FIG. 2B is a top view of the robotic arm of FIG. 2A;

FIG. 2C is a side view of the robotic arm of FIG. 2A;

FIG. 2D is a schematic side view of a gripper of the robotic arm with fingers inserted into outer cores of a block that are exerting a force laterally inward;

FIG. 2E is a schematic side view of a gripper of the robotic arm with fingers inserted into a single core of a block that are exerting a force laterally outward;

FIG. 3A is a perspective view of the base of the robotic block laying machine showing the robotic arm configured with a gripper having a pair of fingers for insertion into internal cores of a block;

FIG. 3B is another perspective view of the base of the robotic block laying machine of FIG. 3A showing the gripper of the robotic arm holding a block in internal cores;

FIG. 4A is a perspective view of an example of a pre-sequenced pallet of cut blocks for use with the block laying machine;

FIGS. 4B to 4E show a sequence of schematic plan views showing the programmed arrangement of pre-sequenced cut blocks for each course of the pallet shown in FIG. 4A;

FIG. 5 is a flowchart of an example of a process for pre-sequencing pallets of blocks required for a build;

FIG. 6 is a flowchart of a specific process for populating sequenced rows of blocks on each pallet; and,

FIG. 7 is a flowchart of a specific process of performing pallet row optimisation for each course of blocks on a pallet.

### DETAILED DESCRIPTION OF THE PREFERRED EMBODIMENTS

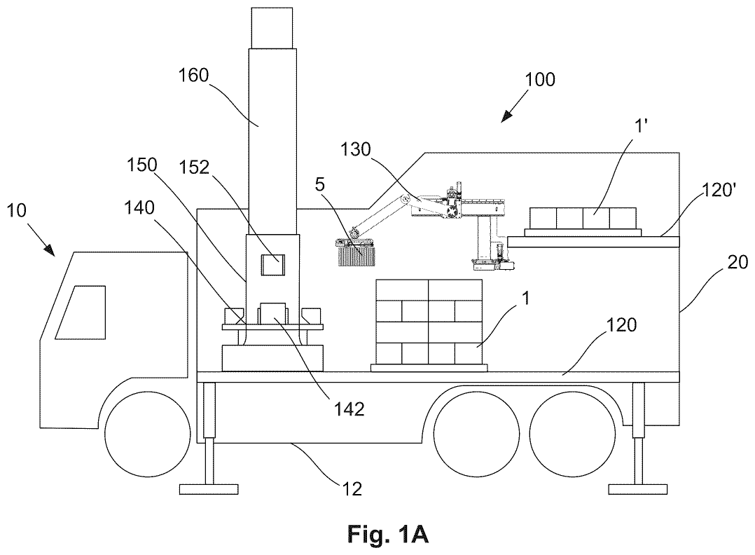

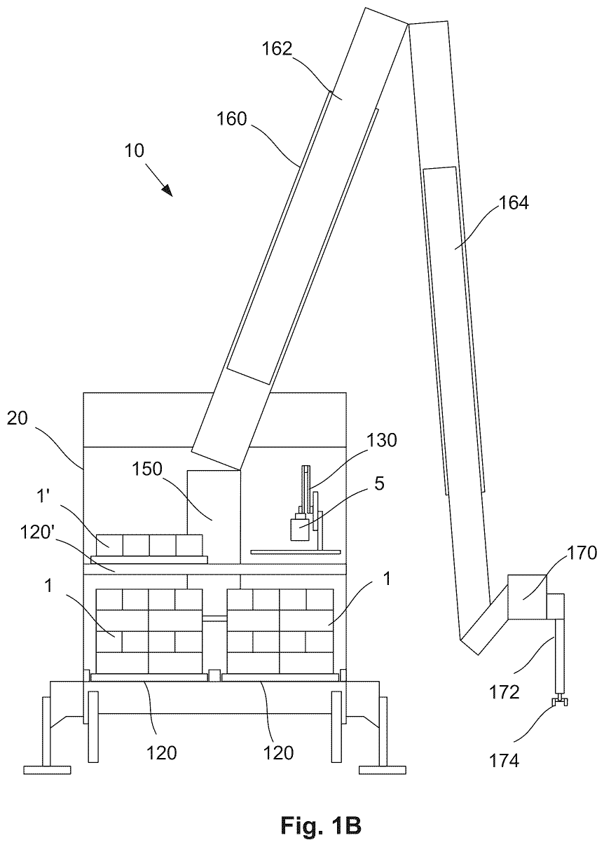

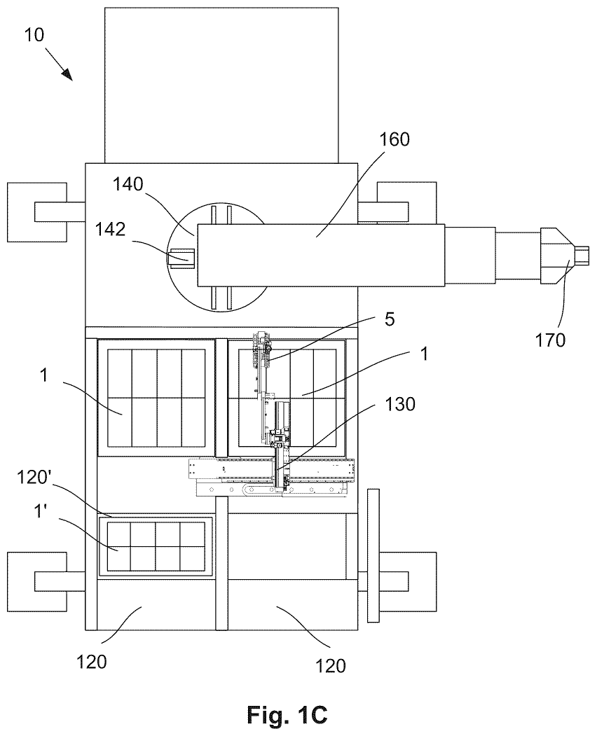

An example of a vehicle 10 which incorporates a robotic block laying machine 100 for use in constructing a block structure will now be described with references to FIGS. 1A to 1C.

The term “block” used herein is a piece of material, typically in the form of a polyhedron, such as a cuboid having six quadrilateral and more typically substantially rectangular faces. The block is typically made of a hard material and may include openings or recesses, such as cavities or the like. The block is configured to be used in constructing a structure, such as a building or the like and specific example blocks include bricks, besser blocks, concrete masonry units or similar.

The term “pallet” as used herein refers to a pack of blocks that are stacked on top of each other course by course. The blocks may be stacked with or without a physical pallet underneath them.

In this example, the vehicle 10 includes a vehicle chassis 12, a base frame 20 mounted to the chassis 12 and a robotic block laying machine 100 mounted from the base frame 20. The base frame 20 is typically a framework capable of structurally supporting the machine 100 and may include base and side components that support parts of the machine 100. The base frame 20 may further include skin panels that substantially cover the machine and assist in protecting internal components of the machine from rain, wind, dust, sunlight and other environmental elements.

The vehicle 10 is typically in the form of a rigid body truck which enables the robotic block laying machine 100 to be drivable to and from building sites on roads. In examples, the truck 1 is a 8×8, 8×6 or 8×4 rigid body truck manufactured for example by Volvo, Mercedes, Iveco, MAN, Isuzu or Hino. The truck has a typical driver's cabin. In an alternative arrangement, a semi-trailer intended for connection to a prime mover using a fifth wheel, may be used instead of a rigid body truck.

The robotic block laying machine 100 includes one or more loading bays 120, 120′ for receiving pallets (i.e. packs) 1, 1′ of blocks 5 stacked with one or more courses of blocks wherein each course comprises a plurality of rows of blocks. A loading bay refers to a location where a pallet of blocks resides in the base of the machine, and may include a conveyer or other mechanism onto which the pack is loaded. In some instances, packs of blocks may remain stationary or alternatively may be moved inside the machine (e.g. by conveyer). The rows of blocks on a course may be rotated with respect to rows of blocks on an adjacent course so that they are arranged in an orthogonal manner on at least some adjacent courses. This is typically done to increase stability of the stacked blocks. The term “row” is therefore a relative term intended to cover blocks that are stacked on a particular course in end-to-end fashion, but in any orientation.

The one or more loading bays 120, 120′ are typically configured to receive pallets of blocks from a forklift or telehandler. The loading bays 120, 120′ may include guide rails to ensure the alignment of pallets as they are loaded into the machine. Loading of pallets may be from the back of the machine, although in other examples loading could occur from the side through suitable access points. In some examples, the machine may include loading bays at different levels or heights, for instance lower-level loading bays may include full pallets of standard blocks whereas higher-level loading bays may include smaller pallets of perhaps special types of blocks or spare blocks. In embodiments, the machine includes loading bays capable of holding two, three, four, five or six pallets. The pallets may be arranged side by side (across the machine) or in a single row (in the longitudinal direction of the machine).

The machine 100 further includes at least one robotic arm 130 configured to pick any individual block 5 directly from a pallet. In one example, the robotic arm 130 is mounted on linear sliding rails that enables the arm to translate in a longitudinal direction of the vehicle as well as widthwise across it. The arm itself may include shoulder and elbow rotary joints as well as wrist joints capable of controlling yaw and pitch of the gripper. The gripper may include finger clamps controllable to open and close in order to grip internal cores of a block. Alternatively, the gripper may be a vacuum gripper configured to pick up a block (e.g. without cores) by applying a suction force to a face of the block. In one example, the machine includes one robotic arm 130 configured as part of a transfer robot for picking a block from a pallet and transferring it to further downstream block handling equipment. In other examples, there may be two or more robotic arms that work simultaneously to unload blocks from multiple pallets.

Finally, the machine 100 further includes a block conveying system that receives blocks from the at least one robotic arm 130 and transports them to a laying head 170 of the machine that lays the blocks in order to create the block structure. In one example, the block conveying system includes a plurality of clamps and shuttles that move the block from the base of the machine to the laying head. Typically, the machine includes a foldable and telescopically extendable boom that unfolds from the base of the machine and wherein the laying head is mounted to a distal end of the boom. The laying head typically includes a lay robot which receives a block delivered through the boom by a boom shuttle system and wherein the lay robot includes a lay gripper which places a block in accordance with the build datafile in order to build the block structure.

The above-described vehicle 10 which incorporates a robotic block laying machine 100 is advantageous as it simplifies block processing in the machine by enabling pallets (i.e. packs of blocks) to be unpacked by a single robotic arm, whereas previously additional robots were required to dehack (i.e. unpack) rows of blocks from a pallet which were placed onto a platform for subsequent pick up and handling by a transfer robot of the machine. Now, the transfer robot is able to pick blocks directly from a stacked pallet. This improves overall reliability of the system and enables a greater throughput and laying rate to be achieved.

A number of further features will now be described.

In one example, one or more of the pallets are stacked with pre-sequenced blocks in accordance with a block sequence generated by a build datafile associated with the block structure. In this example, blocks are arranged onto pallets in an order required for the build resulting in pre-sequenced pallets which are loaded into the machine in a specific order according to a pallet identification (Pallet ID) number assigned to each pallet. The pre-sequenced pallets may be manually stacked or robotically stacked in accordance with a datafile defining the pallet characteristics, including for instance block type, size, orientation etc. By providing pallets of pre-sequenced blocks to the machine, throughput of blocks through the system can be improved as the blocks do not require any further processing (such as cutting etc.) and waste is able to be minimised as all blocks on the pre-sequenced pallets are required for the build and there will be no waste associated with off-cuts that are unusable etc.

In this regard, it will be appreciated that the pre-sequenced blocks typically include blocks of varying length that may be pre-cut or moulded to that length. For the purposes of the following description, these variable length blocks (less than full size) will be referred to as pre-cut blocks. In some examples, the pre-sequenced pallets may comprise pre-sequenced pre-cut blocks only whilst full size blocks may be provided on regular pallets. Accordingly, the machine may be fed with pallets of regular full-sized blocks along with pallets of pre-sequenced pre-cut blocks. Alternatively, each pallet may be pre-sequenced and include a mixture of both full size and pre-cut blocks. Providing pallets of pre-sequenced pre-cut blocks to the machine removes the need for an on-board saw or cutting system to cut full-size blocks to the size required in the build plan. This further simplifies the machine, removing additional on-board block processing, and enables the machine to be a near zero waste system which improves the environmental footprint of the robotic block laying system.

Alternatively, instead of pre-sequencing pallets, pre-cut blocks may be stacked on pallets according to their cut size. So for instance, packs of ¼ or ½ or ¾ or other length blocks may be loaded into the machine along with packs of full-size blocks.

For blocks having internal cores, the at least one robotic arm is configured with a gripper having a pair of fingers that are insertable into one or more of the internal cores to apply a force thereby enabling the arm to pick up a block directly from the pallet. In previous iterations of the machine, the gripper had a pair of clamps capable of clamping the outside of a block, either by its ends or sides. However, such a clamping approach does not permit blocks to be picked directly from a pallet where blocks are closely packed together and their ends and sides are not accessible. By providing gripper fingers insertable into cores of a block, this enables blocks to be picked up when they cannot be clamped in a conventional manner.

The gripper is operable in one of two ways. Firstly, the pair of fingers may be inserted into a single core and controllable to each apply an outwardly directed (i.e. opposing) force to faces of the core. Such a gripping method is typically used for a block with only a single core and wherein both gripper fingers must enter the same core and exert a force to hold the block.

Secondly, the pair of fingers may be inserted into separate cores and controllable to each apply an inwardly directed force to faces of the separate cores. Any suitable cores of the block may be used to insert the fingers, but typically outermost cores would be used and an inwardly directed (i.e. squeezing) force applied to hold the block.

The fingers of the gripper typically include gripper pads made for instance from rubber that contact the internal faces of the block core(s) and increase friction between the fingers and the block. The pads may be interchangeably mounted to either side of each finger depending on the size of blocks that must be picked. In other examples, the fingers may be rotatable to present the pads on the desired side of each finger in accordance with the specific block being picked.

In other arrangements, for blocks without internal cores, the at least one robotic arm may be configured with a vacuum gripper to pick up a block directly from the pallet by applying a suction force to a face of the block.

Typically, the at least one robot arm includes a vision sensor for scanning one or more blocks on a pallet, wherein an image captured by the vision sensor is processed to identify a target block to be picked and calculate an offset between an expected position and an actual position of the target block. A machine control system will typically communicate the position of a particular pallet to the transfer robot as well as the block identification (ID), position and orientation of the blocks on that pallet so that the transfer robot is able to move to an approximate position where a block is expected to be, with the vision sensor then able to guide the robot to precisely pick the target block. In one example, the vision sensor may be a 3D Time of Flight (ToF) sensor such as an IFM O3D302 which builds an image using an infrared point cloud.

A preferred mounting location for the vision sensor is on the robotic arm proximate the gripper so that an image of the pallet looking directly down from above may be captured when the robotic arm is moved above the pallet. Such a mounting position further enables images to be captured of a pallet without occlusion from other objects in the machine.

In operation, the robotic arm is moved so that the gripper is positioned above the expected location of the target block on the pallet, the height of the gripper above the pallet sufficient to obtain an image of at least the entire target block and optionally part of a block either side. An image is captured and processed to determine an X, Y and C (yaw) offset from an expected position. The vision sensor further determines a Z distance (e.g. height) indicative of the vertical distance between the sensor and the block.

After having determined the distance between the sensor and the block as well as the X, Y and C offsets, the position of the robotic arm is adjusted to move the arm in accordance with those parameters to just above an ideal pick position. The arm is then controlled to pick the block by inserting the gripper fingers into the one or more cores and then closing or opening the gripper to pick the block.

As previously discussed, the block conveying system typically includes a plurality of clamps and shuttles that move the block from the base of the machine to the laying head. More specifically, the block conveying system may be configured to include a tower mounted to the base for rotation about a vertical axis, the tower having a tower shuttle that runs along a tower track for transporting a block up the tower. A foldable and telescopically extendable boom is typically pivotally mounted to the tower about a horizontal axis, wherein rotation of the tower sweeps the boom radially about the vertical axis and wherein the laying head is mounted to a distal end of the boom, the boom having a shuttle system for transporting blocks from the tower to the laying head. A carousel is also located around a base of the tower and rotatable about the vertical axis independently of the tower, the carousel having one or more clamping bays for receiving blocks from the at least one robotic arm. In use, the at least one robotic arm is configured to transfer a block picked from a pallet to a clamping bay of the carousel which rotates to a position proximate the tower track for transfer of the block to the tower shuttle which conveys the block up the tower where it is then transferred to the boom shuttle system and finally to the layhead.

Referring now to FIGS. 1A to 1C, the vehicle 10 which incorporates a robotic block laying machine 100 will be described in further detail.

The vehicle 10 is in the form of a truck that supports the robotic block laying machine 100 which is mounted on a frame 20 on the chassis 12 of the truck. The frame 20 provides additional support for the componentry of the block laying machine 100 beyond the support that would be provided by a typical truck chassis. The frame 20 further supports packs or pallets of blocks 1, 1′ that are loaded into the back of the machine using a forklift or telehandler.

The machine 100 provides side-by-side rear loading bays 120 into which pallets of blocks are loaded. The loading bays 120 can each accommodate two pallets of blocks, whilst upper loading bays 120′ can accommodate additional smaller pallets of blocks such as special cuts or spares. The pallets of blocks 1 in the lower loading bays 120 are typically moved as far forward in the machine as possible to minimise distance that the transfer robot 130 needs to travel to pick blocks from the pallets 1 and move them to the carousel 140 which improves efficiency of throughput.

The transfer robot 130 is mounted to one side of the frame 20 of the machine 100 and is configured to slide along rails in both a lengthwise and widthwise direction of the machine in order to access blocks in different pallets as well as move to place a block 5 into the carousel 140. The carousel 140 is located coaxially with the tower 150, at the base thereof and is able to rotate independently of the tower. The carousel 140 includes a plurality of clamping bays 142 configured to receive blocks from the transfer robot 130. The carousel 140 is rotatable to a position proximate a tower track on which a tower shuttle 152 runs up and down to receive the block 5 from the carousel clamp 142. The carousel 140 transfers the block via the tower 150 to an articulated and telescoping boom 160 comprising first boom element 162 in the form of a telescopic boom and second boom element 164 in the form of a telescopic stick. Each element of the folding telescopic boom 160 has a shuttle located inside on a longitudinally extending track in the element, to transport a block along the longitudinal extent of the element. The blocks are moved through the inside of the folding telescoping boom 160 by the linearly moving shuttles. The shuttles are equipped with grippers that pass the block from shuttle to shuttle.

A laying head 170 is mounted at a distal end of the boom 160. The laying head typically includes a laying robot 172 having a robotic arm and gripper 174 configured to receive a block transported through the boom 160 and subsequently lay it in accordance with instructions provided in a build datafile. The laying head 170 may additionally include an adhesive applicator that applies adhesive onto a block 5 prior to it being laid.

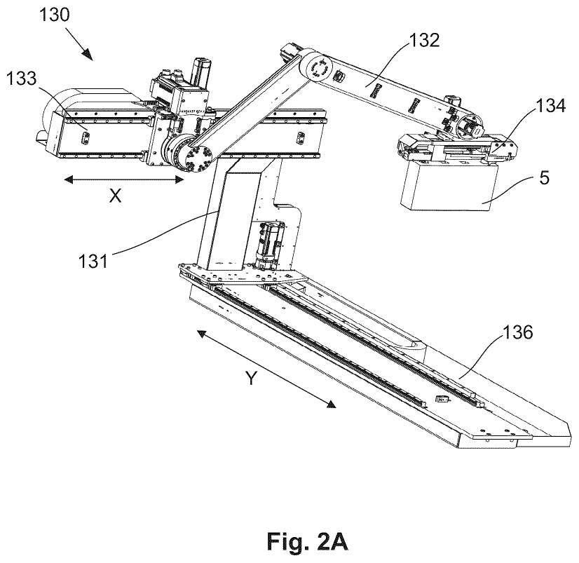

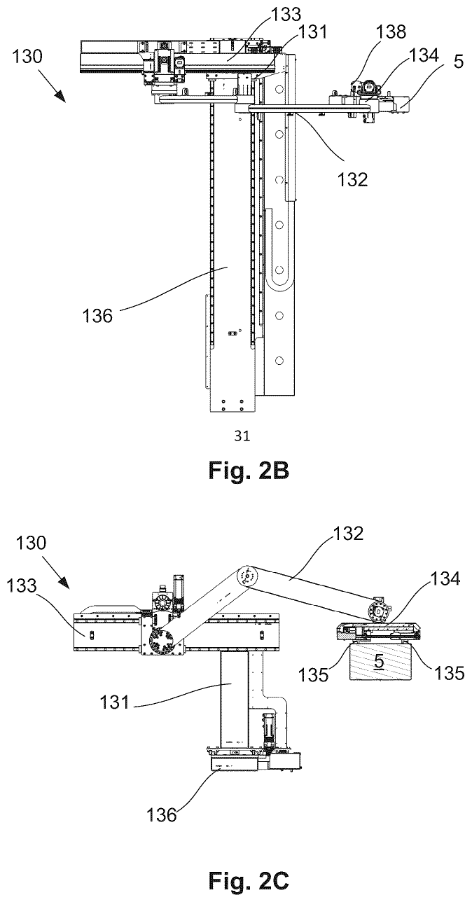

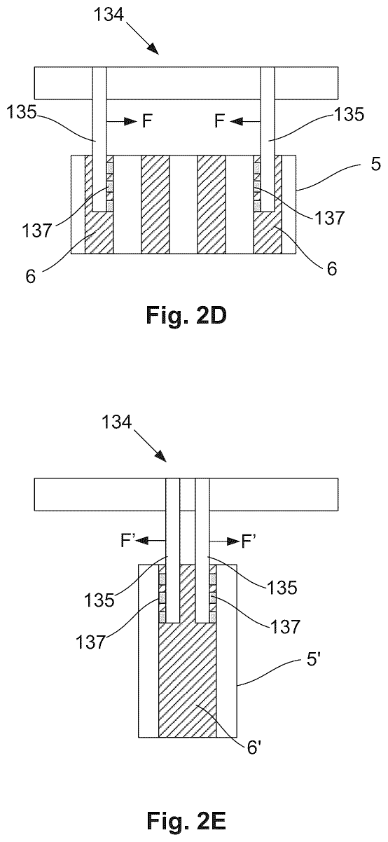

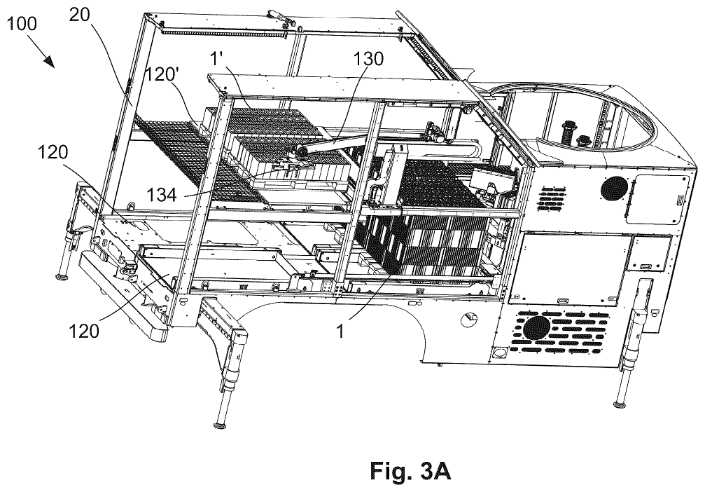

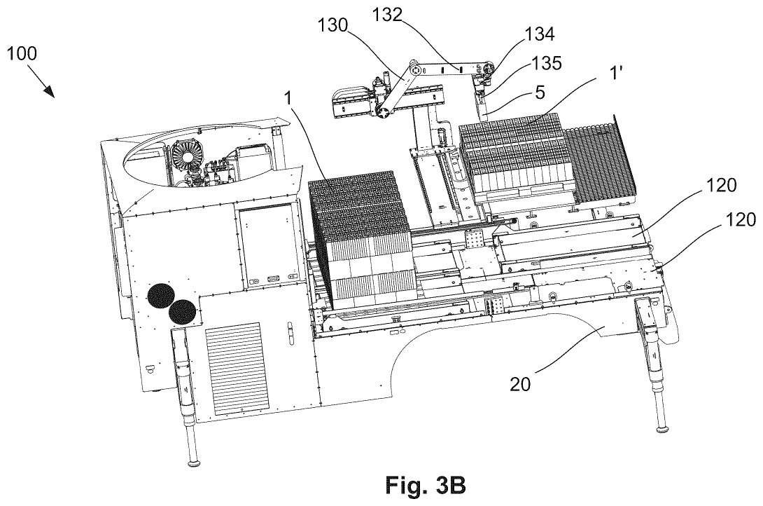

Now referring to FIGS. 2A to 2E and FIGS. 3A to 3B, an example of the at least one robotic arm 130 (i.e. of the transfer robot) will be described in further detail.

The transfer robot 130 is a six-axis mechanism mounted on linear sliding rails 133 and 136 that enables the arm 132 to translate in a longitudinal direction X of the vehicle 10 as well as widthwise Y across it. The sliding rails 133 are mounted to a section including a tower portion 131 that is adapted to translate along the rails 136 in the Y direction. The rails 136 are mounted to a section that is fixed to the frame 20 of the machine 100. In this example, the arm 132 includes shoulder and elbow rotary joints as well as wrist joints capable of controlling yaw and pitch of a gripper 134. The gripper 134 includes gripper fingers 135 controllable to open and close in order to grip internal cores of a block. The fingers 135 include pads 137 (typically made from rubber) attached thereto for contacting faces of internal cores of the block.

In FIG. 2D, the pair of gripper fingers 135 of the transfer robot 130 are shown inserted into separate cores 6 and controllable to each apply an inwardly directed force F to faces of the separate cores 6 of the block 5. Any suitable cores of the block may be used to insert the fingers, but typically outermost cores would be used and an inwardly directed (i.e. squeezing) force applied to hold the block. In FIG. 2E, there is shown an example of the pair of gripper fingers 135 of the transfer robot 130 inserted into a single core 6′ of a block 5′ and controllable to each apply an outwardly directed (i.e. opposing) force F′ to faces of the core 6′ in order to pick up and hold the block 5′.

A vision sensor 138 such as an IFM O3D302 is shown mounted to the gripper 134 of the transfer robot 130 in FIG. 2B so as to have a field of view looking directly down from the gripper 134 so as to be able to image at least part of an upper course of a pallet of blocks in a loading bay.

In operation, a control system of the machine 100 determines the next required block to be loaded into the carousel 140 in accordance with the build datafile. The location of the next required block is determined including which pallet it is located on and its position and orientation on the pallet. The transfer robot 130 is then moved over the expected position of the next required block at a height sufficient to scan the block plus typically at least an adjacent core of a block either side of the target block.

The vision sensor 138 then performs a scan and captures an image of the block on the pallet. Once the block has been identified, the image is then processed to obtain the X, Y position and C (yaw) offset from the expected pose of the block. The vision sensor 138 additionally obtains the Z height (i.e. distance between the sensor and the block) which is used during the pick to ensure the fingers are inserted deep enough into the core(s) so that the entire gripper pad makes contact.

Finally, the transfer robot 130 is moved to pick the block from the pallet. The transfer robot 130 is moved to just above the measured block height whilst adjusting its position in accordance with the determined X, Y and C offsets to ensure that the gripper is in the correct location relative to the block in order to pick it. The gripper fingers 135 are then moved into the block cores and the gripper is opened or closed (depending on how the gripping force needs to be applied for the particular block) in order to grab the block. The robot arm 132 is then moved vertically up and clear of surrounding blocks before the transfer robot 130 moves to place the block into an open clamp 142 of the carousel 140. In one example, the carousel 140 is a multi-bay carousel having at least six clamping bays with a single loading point that receives blocks from the transfer robot 130.

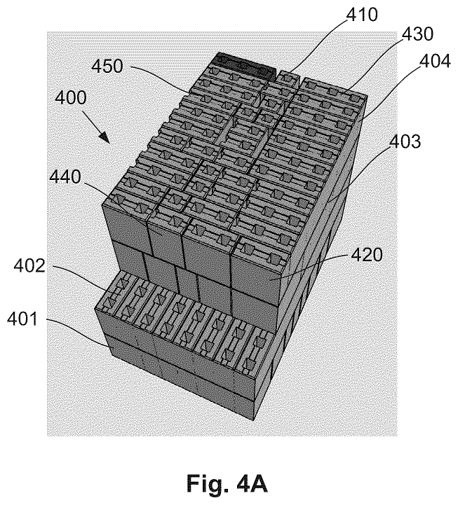

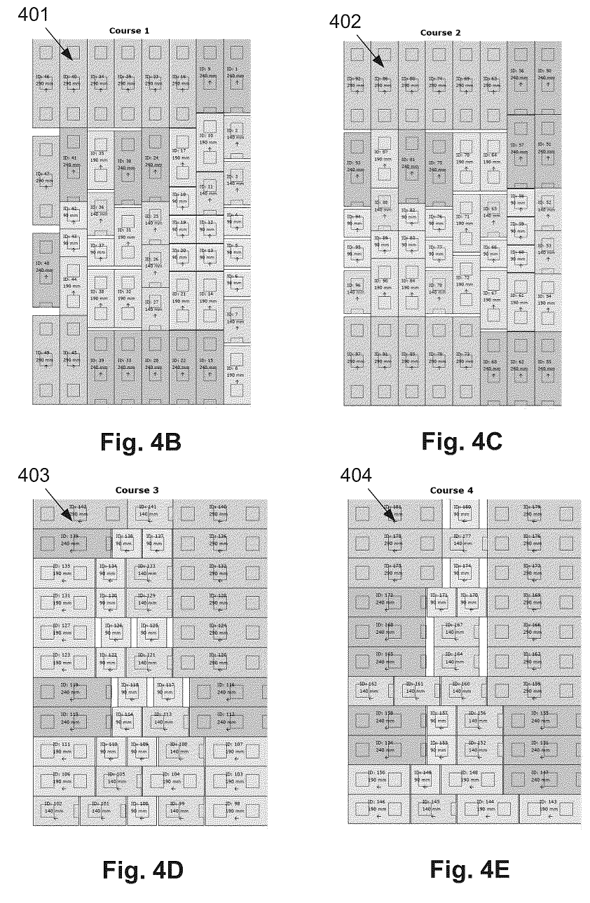

Referring now to FIGS. 4A to 4E, an example of a pre-sequenced pallet of pre-cut blocks is shown. In this example, the pallet 400 includes four courses 401, 402, 403, 404 of blocks. Blocks in courses 401, 402 are orientated in one direction so that rows of blocks extend along the length of the pallet and blocks in courses 403, 404 are orientated in an orthogonal direction so that rows of blocks in courses 403, 404 extend across a width the pallet. In this example, the pallet 400 includes quarter length blocks 410, half length blocks 420, three quarter length blocks 430, three eighth length blocks 440 and five eighth length blocks 450. The plan views of courses 401, 402, 403 and 404 are shown in FIGS. 4B to 4E. The pre-cut blocks in each course are pre-sequenced to correspond with the order in which they are required in the build datafile. The blocks required for use earlier in the build sequence are located on the upper course with blocks required later located on lower courses. Blocks on each course are arranged in rows defined by blocks in end-to-end relation in a single line. In the diagrams in FIGS. 4B to 4E, the block ID numbers relate to the order in which the blocks are sequenced in the pack, the dimensions refer to the block cut-length and the arrow refers to the orientation of the block. Gaps may be provided between blocks although this is not necessary, and some blocks may be in abutment with an adjacent block on that course.

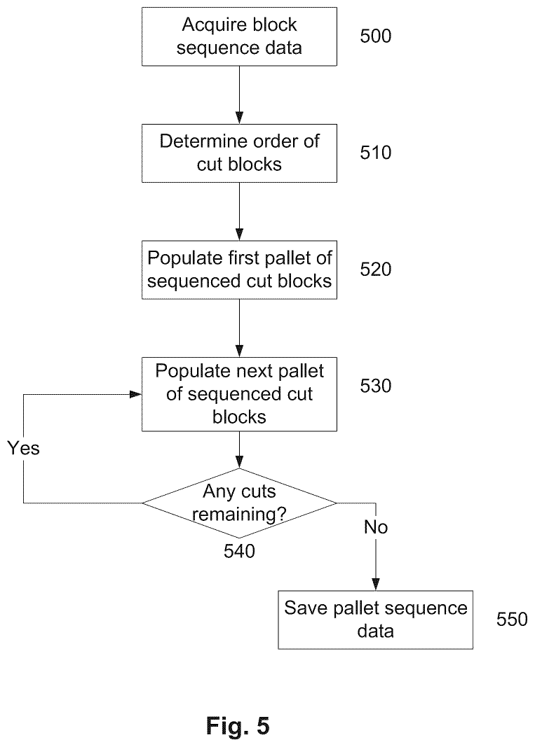

Referring now to FIG. 5, an example flowchart of a process for pre-sequencing pallets of blocks required for a build will be described.

In this example, at step 500 block sequence data is acquired. In this regard, a build datafile indicative of all of the blocks, including their identification number (ID), type, size, position and order in which they are laid is obtained for a given structure to be constructed.

At step 510, the process determines an order of cut blocks from the block sequence data obtained from the datafile. A sequence list is generated in reverse order of blocks being laid. In other words, the last cut brick to be laid is the first brick in the cut brick sequence for palletization and the first cut brick to be laid is the last brick in the cut brick sequence for palletization. In this manner, the sequenced pallets are also generated in reverse order of use (i.e. last to first). This ensures that the blocks are positioned on the pallets in the correct sequence required for depalletization by the at least one robotic arm in the base of the machine.

At step 520, the process populates the first pallet of sequenced cut blocks by generating rows containing the cut blocks for each course according to the sequence list determined in step 510. Once the pallet is full, the process proceeds to populate the next pallet of sequenced cut blocks at 530. This process repeats until it has been determined that no more cuts are remaining in the sequence at step 540 and the pallet sequence data is then saved at step 550. The pallet sequence data may include a pallet ID and the ID, type, size, position and orientation data of all blocks on the pallet.

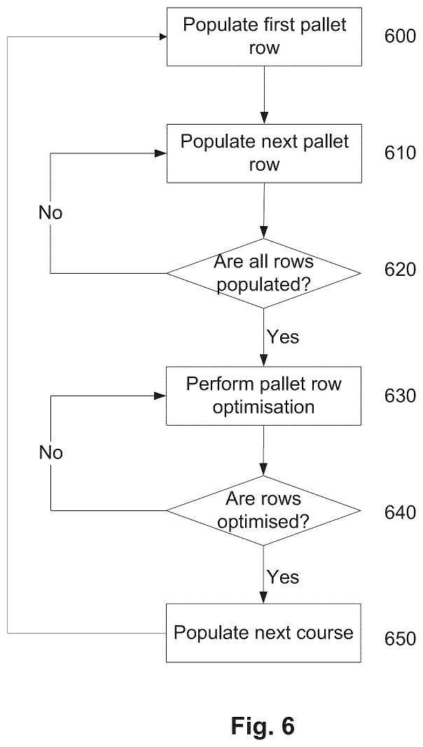

In FIG. 6 there is provided a flowchart of a specific process for populating sequenced rows of blocks on each course of the pallet.

At step 600, the first pallet row is populated. Once the ordered list of cut bricks has been obtained, the process begins to sequence blocks onto pallets, starting with the last pallet of cut bricks required for the build. The pallets are stacked in courses, each course having multiple rows of blocks (a row defined as blocks arranged in an end-to-end fashion in a single line). A row can be lengthwise along the length of a pallet, or widthwise across the width of the pallet. Rows typically alternate in direction between each course or every couple of courses to increase overall stability of the stacked pallet.

For the first pallet to be populated with cut bricks, the process attempts to sequence the cut bricks in reverse laying order row by row for the first course. Blocks are added to the row in sequenced order until the length of the total blocks plus the minimum gaps required between blocks is less than the row length. Typically, a minimum gap is provided for between blocks, although this is not essential, and in other examples no gap may be defined. Row length is configurable, by default the row length for the first course is the pallet length and then the second course is the pallet width, and the row length then continues to alternate for the remaining courses. In alternative examples, the row length may be the pallet length or pallet width in adjacent courses (meaning two adjacent courses have blocks stacked in the same direction)

Each pallet row of a course is populated in this manner until at step 620 it is determined that the pallet course is full (width of the brick plus the minimum gaps between them is less than the pallet size (pallet length or width depending upon the direction in which the rows are arranged on a course). It will be appreciated that a resulting course will have rows of varying length depending upon the block sequence and one or more rows on a course may have room for additional blocks (corresponding to an out of sequence block size).

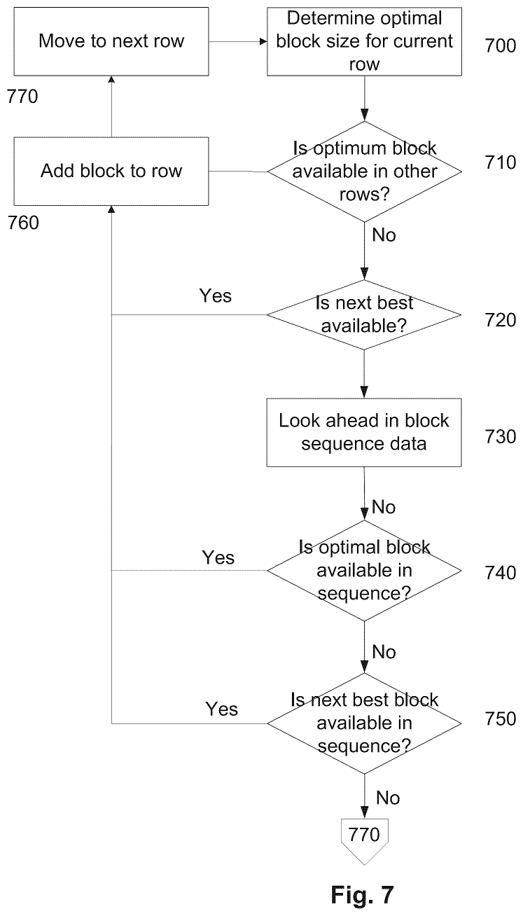

A list of pallet rows is generated that require optimising (i.e. where an additional block could be placed in order to fill the row or at least minimise the leftover space in the row). Only rows that have room for at least the smallest cut size block are included in this list). At step 630 pallet row optimisation is performed as shall be described in further detail in FIG. 7 whereby incomplete rows are filled with available blocks that fit into the available space. This process continues until it has been determined at step 640 that all pallet rows have been optimised at step 650 the process then begins to populate pre-sequenced blocks for the next course on the pallet.

An example of the pallet row optimisation process shall now be described in further detail with reference to FIG. 7.

For each of the rows of course requiring optimisation, at step 700 the process first determines what the optimal size block is that would fill the row (i.e. the largest cut size that would still fit in the available space in the row). For a current row being optimised, the method initially seeks at step 710 to find the required block size in any of the remaining rows requiring optimisation for that course. If the required block is found, then it is taken from that other row at step 760 and placed in the current row. If the required block cannot be found in any other row to be optimised, then the method searches for the next best block at step 720 (next size smaller than the optimal block) in the other rows and if it is found then it takes that block for the current row at step 760.

If no suitable block can be found in steps 710 and 720 and the pallet row still isn't optimised, the method looks ahead in the cut brick sequence at step 730 to find the optimal block required to fill the remaining space. The method does not look ahead further than an average number of cut blocks on a pallet course to minimise the likelihood of a block being stacked on a course where it cannot be accessed by the at least one robot when required in the block laying sequence. For instance, if an earlier block in the block laying sequence is taken and stacked on a lower course than desirable in order to optimise a pallet row on that course, then it must be ensured that the out of sequence block is able to accessed when needed. For examples of the machine having block storage bays on board the machine, an additional check performed when taking a block from earlier in the block laying sequence is to determine how many block storage bays are being used at that point in the sequence compared with the maximum number of storage bays the machine has available. If there are storage bays available then the machine may be able to temporarily store any blocks that may be necessary in order to ensure continuous build operation. If it is determined at step 740 that the optimal block is available in the sequence, then this block is added to the current row at step 760.

If the optimal sized brick cannot be found in the sequence by looking ahead, then the method will search for the next best brick to use at step 750 and if the next best block is found this is added to the current row at step 760. Once the current row has been optimally filled, the process moves onto the next row requiring optimisation at step 770.

The above methods may be used to create a palletization datafile containing the block ID, type, size, position (X, Y, Z) and rotation for each block on the pallet. Such datafile can be used by an operator to manually stack every pallet or be input to a robotic handling system for instance in a plant which automatically stacks each pallet in accordance with instructions contained in the datafile. The result is a plurality of pallets of pre-sequenced cut blocks which are loaded into the machine in an order in which the blocks are required for the build.

In at least one example, the above-described vehicle which incorporates a robotic block laying machine provides a machine capable of robotically laying blocks without further additional processing such as cutting blocks to size. Blocks are provided pre-cut or moulded to size on pre-sequenced pallets which can be loaded into the machine alongside pallets of full-size blocks. In this way, the machine can achieve near zero waste as every block loaded into the machine corresponds to a block used in the build. By eliminating cutting processes on the machine, throughput of blocks through the machine is faster thereby improving lay rate of the machine. Additionally, the ability to pick individual blocks directly from a pallet loaded into the machine, simplifies the robotic handling processes in the base of the machine (such as dehacking rows of blocks from pallets prior to the one or more robot arms grabbing individual blocks for transport through the machine to the laying head). The machine is therefore an improved block laying machine that is faster, more reliable and capable of significantly reducing construction waste.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1. A vehicle which incorporates a robotic block laying machine for use in constructing a block structure, the vehicle including:
a) a vehicle chassis:
b) a base frame mounted to the chassis; and,
c) a robotic block laying machine mounted from the base frame, the machine including:
i) one or more loading bays for receiving pallets of blocks stacked with one or more courses of blocks wherein each course comprises a plurality of rows of blocks;
ii) at least one robotic arm configured to pick any individual block directly from a course of the pallet; and,
iii) a block conveying system that receives blocks from the at least one robotic arm and transports them to a laying head of the machine that lays the blocks in order to create the block structure.

2. The vehicle according to claim 1, wherein one or more of the pallets are stacked with pre-sequenced blocks in accordance with a block sequence generated by a build datafile associated with the block structure.

3. The vehicle according to claim 2, wherein the courses of blocks arranged in a pre-sequenced order include blocks of varying length.

4. The vehicle according to claim 3, wherein the blocks of varying length are one of:
a) Pre-cut; and,
b) Moulded.

5. The vehicle according to any one of the preceding claims, wherein for blocks having internal cores, the at least one robotic arm is configured with a gripper having a pair of fingers that are insertable into one or more of the internal cores to apply a force thereby enabling the arm to pick up a block directly from the pallet.

6. The vehicle according to claim 5, wherein the pair of fingers are inserted into a single core and controllable to each apply an outwardly directed force to faces of the core.

7. The vehicle according to claim 5, wherein the pair of fingers are inserted into separate cores and controllable to each apply an inwardly directed force to faces of the separate cores.

8. The vehicle according to claim 7, wherein the separate cores are outermost cores of a block.

9. The vehicle according to any one of claims 5 to 8, wherein the fingers of the gripper have gripper pads fixed to sides of each finger.

10. The vehicle according to any one of claims 1 to 4, wherein for blocks without internal cores, the at least one robotic arm is configured with a vacuum gripper to pick up a block directly from the pallet.

11. The vehicle according to any one of the preceding claims, wherein the at least one robot arm includes a vision sensor for scanning one or more blocks on a pallet, wherein an image captured by the vision sensor is processed to identify a target block to be picked and calculate an offset between an expected position and an actual position of the target block.

12. The vehicle according to claim 11, wherein the vision sensor is mounted to the robot arm proximate the gripper.

13. The vehicle according to claim 12, wherein the robot arm is moved so that the gripper is positioned above the expected location of the target block on the pallet, the height of the gripper above the pallet sufficient to obtain an image of at least the entire target block.

14. The vehicle according to claim 13, wherein an image is captured and processed to determine an X, Y and C (yaw) offset from an expected position.

15. The vehicle according to claim 14, wherein the vision sensor further determines a Z height indicative of the vertical distance between the sensor and the block.

16. The vehicle according to claim 15, wherein the determined Z height and X, Y and C offsets are used to control the robot arm to move the gripper just above the block.

17. The vehicle according to claim 16, wherein the robot arm is controlled to pick the block by inserting the gripper fingers into the one or more cores and then closing or opening the gripper to pick the block.

18. The vehicle according to any one of claims 11 to 17, wherein the vision sensor is a time of flight (ToF) sensor.

19. The vehicle according to any one of the preceding claims, wherein the block conveying system includes:
a) a tower mounted to the base for rotation about a vertical axis, the tower having a tower shuttle that runs along a tower track for transporting a block up the tower;
b) a foldable and telescopically extendable boom pivotally mounted to the tower about a horizontal axis, wherein rotation of the tower sweeps the boom radially about the vertical axis and wherein the laying head is mounted to a distal end of the boom, the boom having a shuttle system for transporting blocks from the tower to the laying head; and,
c) a carousel located around a base of the tower and rotatable about the vertical axis independently of the tower, the carousel having one or more clamping bays for receiving blocks from the at least one robotic arm,
wherein, in use, the at least one robotic arm is configured to transfer a block picked from a pallet to a clamping bay of the carousel which rotates to a position proximate the tower track for transfer of the block to the tower shuttle which conveys the block up the tower where it is then transferred to the boom shuttle system.
